(19) United States
(12) Patent Application Publication
(10) Pub. No.: US 2017/0315972 A1
(43) Pub. Date: Nov. 2, 2017

(54) TRANSFORMING WEB-BASED DIGITAL CONTENT TO ENABLE NATIVE RENDERING

(71) Applicant: Google Inc., Mountain View, CA (US)

(72) Inventors: Kyle Lampert, Boston, MA (US); Imad Jureidini, Arlington, MA (US); Regis Gaughan, Cambridge, MA (US); Charles Edward Garofalo, Framingham, MA (US)

(21) Appl. No.: 15/139,806

(22) Filed: Apr. 27, 2016

(51) Int. Cl. G06F 17/22; H04L 29/08

(52) U.S. Cl. CPC G06F 17/2264; G06F 17/2247; H04L 67/02

(57) ABSTRACT

A content distribution system transforms digital content items published by a publisher in a markup language according to a native data model that enables native rendering of those content items. Components of a digital content item transformed according to the native data model are organized as an ordered stack of components that can each be independently and natively rendered. The components of a transformed digital content item are rendered using native display services available on the platform on which the item is being rendered without requiring specialized rendering software. To transform digital content items, the content distribution system includes transformation rules that encapsulate the native data model. A transformation rule describes how at least one type of component of a digital content item is to be transformed to make the component compliant with the native data model that enables native rendering.

### TECHNICAL FIELD

This disclosure relates generally to the field of digital content delivery, and specifically to transforming web-based digital content to enable native rendering.

### BACKGROUND

Many computing systems run applications for consuming digital content. Examples of digital content include digital news and magazine articles, blogs, e-books, etc. The digital content is often formatted according to a web-based markup language that requires the application to render the content in a web view. In particular, to render the content, the application loads the digital content and feeds the loaded content to a scripting-based rendering engine. The rendering engine processes the loaded content and generates web-based display of the content.

Displaying content in a web view has several drawbacks. First, processing content in a scripting-based rendering engine is often slow and results in a sluggish user experience for a user viewing the content. Second, native services provided by the operating system of the computing system are not available to manage content rendered in a web view. Therefore, services that can make the rendering of content more efficient and less error prone, (for example, content caching and memory management), cannot be utilized by the application that renders the content. Third, content displayed in a web view cannot utilize display effects, (for example, transitions and parallax effects), that are available to content displayed natively. Therefore, a user viewing the content in the web view will noticeably perceive a difference in the quality and sophistication of the viewing experience relative to natively displayed content.

### SUMMARY

The previously described and other needs are met by a computer-implemented method and a non-transitory computer-readable storage medium storing executable code, and a system for processing content to enable native rendering.

One embodiment of the computer-implemented method includes receiving from a publisher of digital content a content item formatted according to a web-based markup language, where the markup language is associated with a web-based rendering engine for rendering the content item. The method also includes parsing the content item to identify a plurality of components of the content item, where a first component of the plurality has a dependent nested component, and transforming the plurality of components into an ordered stack of components based on a transformation rule associated with native rendering. The transformation rule specifies that the ordered stack of components include the nested component as a top-level component independent of the first component. The method also includes transmitting the ordered stack of components to a client for native rendering without invoking the web-based rendering engine.

One embodiment of the non-transitory computer-readable storage medium stores executable computer program instructions that, when executed by a processor, cause the processor to receive from a publisher of digital content a content item formatted according to a web-based markup language, where the markup language is associated with a web-based rendering engine for rendering the content item. The instructions, when executed, also cause the processor to parse the content item to identify a plurality of components of the content item, where a first component of the plurality has a dependent nested component, and transform the plurality of components into an ordered stack of components based on a transformation rule associated with native rendering. The transformation rule specifies that the ordered stack of components include the nested component as a top-level component independent of the first component. The instructions, when executed, also cause the processor to transmit the ordered stack of components to a client for native rendering without invoking the web-based rendering engine

One embodiment of the device comprises a processor configured to execute modules, and a memory storing the modules. When the modules are executed by a processor, the processor receives an ordered stack of components associated with a content item from a content distribution system, where the ordered stack of components includes a plurality of top-level components that are to be natively rendered. The processor also receives a style definition associated with the ordered stack, the style definition specifying a visual style to be applied to the ordered stack when the ordered stack is natively rendered, and renders, using native rendering controls provided by an operating system executing on the processor, each of the plurality of top-level components in the ordered stack based on an order of the plurality of top-level components and the style definition.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the disclosed subject matter.

### BRIEF DESCRIPTION OF THE DRAWINGS

FIG. 1 shows a computing environment for distributing digital content to users of a content distribution system.

FIG. 2 is a block diagram illustrating details of the content distribution system, according to an embodiment.

FIG. 3A illustrates a conceptual diagram of components of a raw content item received from the publisher, according to an embodiment.

FIG. 3B illustrates a conceptual diagram of transformed components generated by the transformation module by applying the flatten transformation rule to the raw content item, according to an embodiment.

FIG. 4 is a flow chart illustrating a process for transforming digital content items received from a publisher to enable native rendering, according to an embodiment.

FIG. 5 illustrates a content item transmitted to a client by the content distribution system, according to an embodiment.

FIG. 6 is a block diagram illustrating details of a client, according to an embodiment.

FIG. 7 is a high-level block diagram of a computer for acting as the content distribution system, the publisher, and/or a client device used by a client, according to one embodiment.

### DETAILED DESCRIPTION

The Figures (FIGS.) and the following description describe certain embodiments by way of illustration only. One skilled in the art will readily recognize from the following description that alternative embodiments of the structures and methods illustrated herein may be employed without departing from the principles described herein. Reference will now be made in detail to several embodiments, examples of which are illustrated in the accompanying figures. It is noted that wherever practicable similar or like reference numbers may be used in the figures to indicate similar or like functionality. This description identifies certain illustrated elements using reference numbers followed by letters. For clarity, this description often uses only the reference number to refer to any or all of the entities having that reference number.

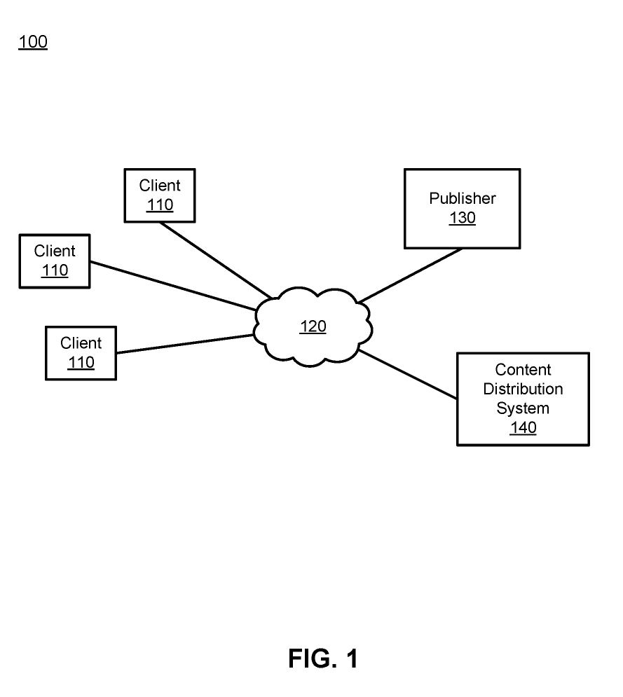

FIG. 1 shows a computing environment 100 for distributing digital content to users of a content distribution system 140. The computing environment 100 includes multiple clients 110, a content distribution system 140, and a publisher 130 connected by a communications network 120. Only one content distribution system 140, one publisher 130, and three clients 110 are shown in FIG.1 in order to simplify and clarify the description. Embodiments of the computing environment 100 may have multiple content distribution systems 140 and publishers 130, and many clients 110 connected to the network 120. Likewise, the functions performed by the various entities of FIG.1 may differ in different embodiments.

The network 120 enables communications among the content distribution system 140, the clients 110 of the content distribution system 140, and the publisher 130. In one embodiment, the network 120 uses standard communications technologies and/or protocols. For example, the network 120 includes communication links using technologies such as, for example, Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, for example hypertext markup language (HTML) or extensible markup language (XML). In some embodiments, all or some of the communication links of the network 120 may be encrypted using any suitable technique or techniques. In another embodiment, the network 120 uses custom and/or dedicated data communications technologies.

The publisher 130 publishes one or more digital content items that are available for transmission to the clients 110 directly or through a third party distribution service, for example, the content distribution system 140. “Digital content” is any machine-readable and machine-storable content, for example, digital magazines, digital newspapers, digital news stories, digital books, and digital articles. A “digital content item” is a particular piece of digital content, for example, an article in a section of a digital magazine issue. The publisher 130 may publish digital content items at regular intervals (e.g., weekly monthly, or yearly) or at irregular intervals. A digital content item may include several components, for example, text, images, videos, audio, animations, and/or embedded programs. The different components of a digital content item are organized according to a specific data model that requires specialized software for rendering the digital content item. For example, a digital content item may be organized as a web-based markup language document, (for example, a hypertext markup language (HTML) document), that requires a markup language compliant reader for rendering the components of the content item.

The content distribution system 140 transforms digital content items published by the publisher 130 based on a data model that enables native rendering of those content items on the clients 110. The data model that enables native rendering is referred to as the “native data model.” Components of a digital content item transformed based on the native data model are organized as an ordered stack or array of components that can each be independently and natively rendered. In one embodiment, the components of a transformed digital content item are rendered using native display services available on the platform on which the item is being rendered, without requiring specialized rendering software. To transform digital content items, the content distribution system 140 includes transformation rules that encapsulate the native data model. A transformation rule describes how at least one type of component of a digital content item is to be transformed to make the component compliant with the native data model that enables native rendering. The content distribution system 140 provides transformed digital content items to the clients 110 for native rendering.

The clients 110 receive and consume digital content items provided by the content distribution system 140. A client 110 may be a computing device capable of receiving user input as well as transmitting and/or receiving data via the network 120. In one embodiment, a client 110 is a conventional computer system, for example, a desktop or laptop computer. Alternatively, a client 110 may be a device having computer functionality, for example, a tablet computer, a mobile phone, an e-reader, or another suitable device. A client 110 is configured to communicate via the network 120.

A client 110 natively renders transformed digital content items received from the content distribution system 140. To natively render a content item, the client 110 utilizes display services and memory management infrastructure provided by an operating system executing on the client 110. The operating system may be a mobile operating system, for example ANDROID OS, or a desktop operating system, for example WINDOWS 10.

Transforming digital content items according to a data model that enables native rendering results in an enhanced user experience when the digital content items are consumed by a user. Specifically, a client 110 is able to load a transformed digital content item for display quickly, as all the necessary content and relevant layout information is locally available. Further, the client 110 uses native services provided by the operating system, (for example, caching and memory management), when natively rendering the content item. With caching, rendering performance is improved as content that was previously rendered can be cached for faster rendering in the future. Native rendering also allows the client 110 to implement visual effects that operate on the individual components of the transformed digital content items. The visual effects add sophistication to the overall user experience when consuming the digital content items, where such a user experience would not be achievable if the digital content items were markup language documents.

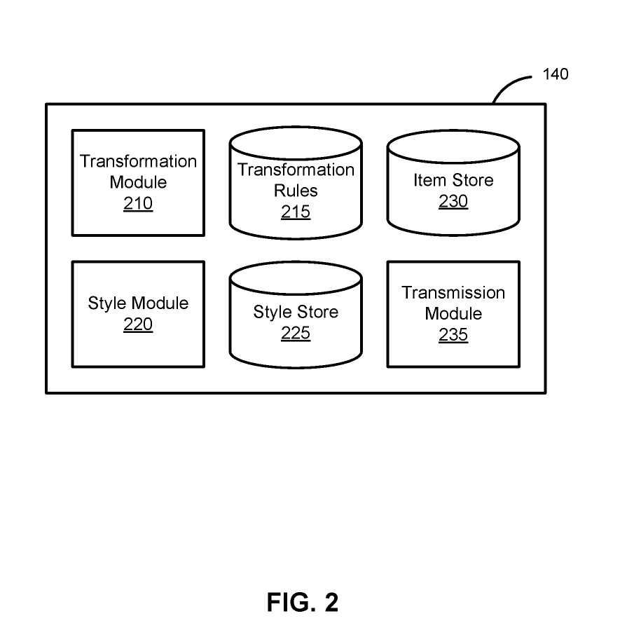

FIG. 2 is a block diagram illustrating details of the content distribution system 140, according to an embodiment. The content distribution system 140 includes a transformation module 210, transformation rules 215, a style module 220, a style store 225, an item store 230, and a transmission module 235.

Those of skill in the art will appreciate that the content distribution system 140 may include different and/or additional modules appropriate for its functionality. Further, the functions of the modules described herein may be distributed among the modules in a different manner. In addition, conventional elements, such as firewalls, authentication and encryption systems, network management tools, load balancers, and so forth are not shown. The content distribution system 140 may be implemented using a single computer, or a network of computers, including cloud-based computer implementations. The computers are preferably server class computers including one or more high-performance computer processors and main memory, and running an operating system such as LINUX or variants thereof. The operations of the content distribution system 140 as described herein can be controlled through either hardware or through computer programs installed in non-transitory computer storage and executed by the processors to perform the functions described herein.

The transformation rules 215, the style store 225, and the item store 230 are implemented using non-transitory computer readable storage devices, and suitable database management systems for data access and retrieval. In one embodiment, the transformation rules 215, the style store 225, and/or the item store 230 are implemented in a database management system, such as a relational database (e.g., My SQL). The transformation rules 215, the style store 225, and the item store 230 may be distributed from one another and/or remotely from the content distribution system 140. The content distribution system 140 includes other hardware elements necessary for the operations described here, including network interfaces and protocols, input devices for data entry, and output devices for display, printing, or other presentations of data.

The transformation module 210 receives digital content items from the publisher 130. In one embodiment, the transformation module 210 transmits a request to the publisher 130 to determine whether new digital content items that were not previously received by the transformation module 210 are available. When new digital content items are available, the transformation module 210 receives those content items from the publisher 130 in response to the request. Alternatively, the publisher 130 automatically transmits a digital content item to the transformation module 210 when a new content item is available. Digital content items received from the publisher 130 are referred to herein as “raw content items.” Raw content items are organized as web-based markup language documents having multiple components. Examples of components included in a raw content item include text, block quotes, images, advertisements, embedded functions, etc. A component of a raw content item may include one or more nested components that are dependent on the component.

The transformation module 210 transforms raw content items received from the publisher 130 according to transformation rules encapsulating the native data model and stored in the transformation rules store 215. In operation, the transformation module 210 parses the raw content item received from a publisher 130 to identify each of the components included in the raw content item. The transformation module 210 transforms the components according to one or more transformation rules. A transformation rule describes how at least one type of component of a raw content item is to be transformed to make the component compliant with the native data model that enables native rendering. Components that are transformed according to the transformation rules store 215 are referred to herein as “transformed components.”

A flatten transformation rule stored in the transformation rules store 215 specifies that each component of the digital content item be an independent top-level component. When the transformation module 210 applies the flatten transformation rule, the transformation module 210 extracts nested components within a top-level component and generates a top-level component from each of the extracted nested components. A nested component may include one or more dependent inline elements. In one embodiment, the transformation module 210 treats an inline element as a nested component and generates a top-level component from the inline element. In an alternative embodiment, the transformation module 210 maintains the dependency between a nested component and its dependent inline element and does not generate a top-level component from the inline element.

The transformation module 210 organizes the generated top-level components as an ordered stack of components. The order of the top-level components matches the order of the components within the raw content item. In one embodiment, for a group of consecutive text components, the transformation module 210 generates a single text top-level component and adds the group of consecutive text components as inline elements of the top-level component. This allows for text formatting, for example bold or italics, to be applied to all of the text elements in the top-level component.

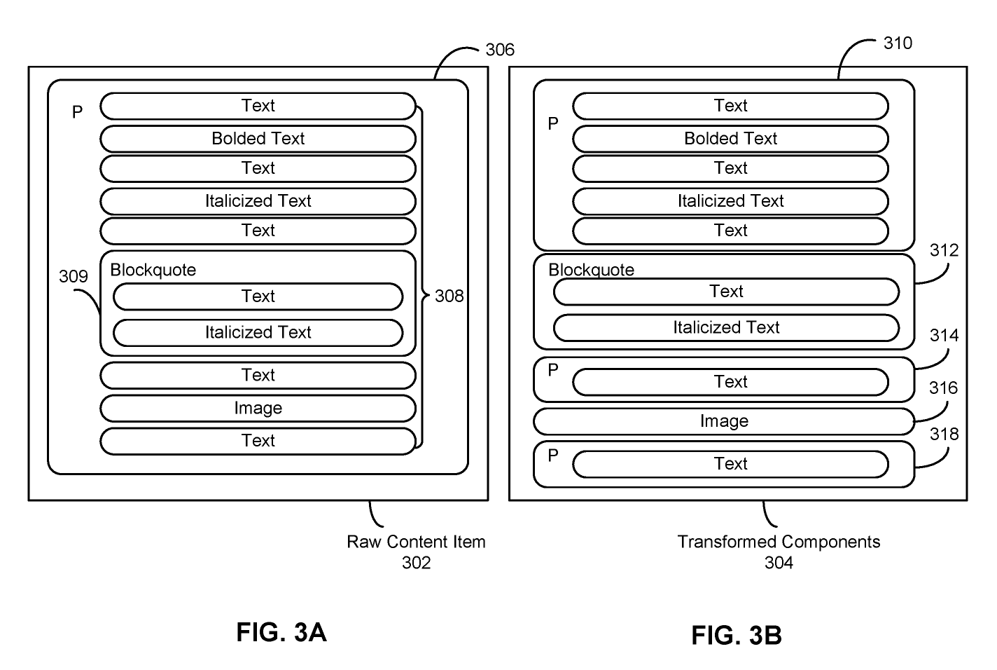

FIG. 3A illustrates a conceptual diagram of components of a raw content item 302 received from the publisher 130, according to an embodiment. As shown, the raw content item 302 includes one top-level component 306 that includes several nested components 308. The nested components 308 are all dependent on the top-level component 306 and are, therefore, treated as a singular block of content when the raw content item 302 is rendered. In the illustrated embodiment, the nested component 309 includes two inline elements labeled “Text” and “Italicized Text.”

FIG. 3B illustrates a conceptual diagram of transformed components 304 generated by the transformation module 210 by applying the flatten transformation rule to the raw content item 302, according to an embodiment. As shown, the transformed components 304 include several top-level transformed components 310-318 generated from the nested components 308 of the top-level component 306 in the raw content item 302. The top-level transformed components 310-318 are independent of one another and do not need to be treated as a singular block of content when rendered. For the first five nested components 308, shown in FIG. 3A, the transformation module 210 generates a single top-level text component 310 that includes the five components. Further, for the nested component 309 of FIG. 3A, the transformation module 210 generates a single top-level block quote component 312 that maintains the dependency of the inline elements labeled “Text” and “Italicized Text.” Thus, in the illustrated embodiment, the transformation module 210 does not treat inline elements as nested components from which top-level components are generated.

Referring to FIG. 2 again, a widget transformation rule stored in the transformation rules store 215 specifies how embedded functions are to be translated into at least one complex component type internal to the content distribution system 140. An embedded function in a raw content item performs a particular function with respect to the raw content item or other content independent of the content item. An example of an embedded function is a social media sharing function for sharing the content item on a social media platform or for displaying third party content from the social media platform as a part of the content item. Another example of an embedded function is a movie show time retrieval function for displaying geographically adjusted movie show times as a part of the content item.

When the transformation module 210 applies the widget transformation rule to a raw content item, the transformation module 210 maps an embedded function (e.g., a widget) in the content item to at least one complex component specified by the widget transformation rule. A complex component is associated with a function that mirrors the embedded function. Rather than having an embedded function, however, the complex component operates as a placeholder for the function. Specifically, a client that renders the complex natively substitutes a program implementing the function when rendering the complex component. An example of a complex component is a social media share button for sharing content on a social media platform. A renderer that renders the social media share button is configured with a function that enables sharing the content item to the social media content item, such that the function is executed when the button is manipulated.

In one embodiment, the transformation module 210 also generates a full view representation and a summary view representation of the transformed content item. The full view representation includes or references each of the transformed components organized in an ordered stack. The full view representation optionally includes a content item header that may be provided by the publisher 130 as header information to be displayed in conjunction with the components of the content item. The summary view representation includes or references a subset of the transformed components. In one embodiment, the transformation module 210 selects the subset of the transformed components based on a summary transformation rule that specifies the type(s) of components and/or the number of components that should be included when rendering a summary of the content item.

The transformation module 210 stores the transformed content item in the item store 230. The transformed content item includes each of the transformed components, a unique identifier assigned to each of the transformed components, and a transformation version. The transformation version indicates a version of the transformation rules applied to the raw content item. The version is consumed by downstream renderers to determine whether the renderer is capable of rendering the transformed content item. The transformation module 210 also generates metadata for the transformed content item. Metadata includes information associated with the content item, for example, a source name, a publication date, and/or an author's name. The transformation module 210 stores the metadata in the item store 230 in conjunction with the transformed content item.

The style module 220 generates a style definition for a transformed content item stored in the item store 230. The style definition specifies visual styles to be applied to the various components of the transformed component item when those components are rendered on a client 110. In operation, the style module 220 selects style templates stored in the style store 225 to generate the style definition. The style templates include templates for block styles, text styles, line styles, custom styles defined by publishers 130, and conditional styles. In one embodiment, each style template stored in the style store 225 is associated with a unique identifier.

Block style templates define how a top-level component in the transformed content item should be displayed as a whole. For example, a block style defines values for margins, padding, and/or background color. Span style templates define how text content should be displayed. For example, a span style defines a font type, a font size, the color of the text, and/or whether the text is bolded or italicized. Line style templates define how a horizontal or vertical line should be displayed. For example, a line style defines a length, thickness, and color of the line. In one embodiment, the style store 225 stores custom style templates received from publishers 130. The custom style templates may be received in conjunction with a raw content item or in an independent communication between the publisher 130 and the content distribution system 140. A custom style template defines style(s) that the publisher 130 wishes to apply to content items published by that publisher 130. A custom style may itself include a block style template, a text style template, and/or a line style template.

The style store 225 also stores conditional style templates that depend on the client on which the content is to be rendered. Specifically, a conditional style template specifies a set of client conditions, and, if those client conditions are satisfied by the client on which a component is being rendered, then the visual style specified by the conditional style template is applied to the component. Examples of client conditions include screen size, screen resolution, input capabilities, etc. In one embodiment, the style store 225 stores a default style template for each type of content that may be present in a transformed content item. The default style template associated with a given type of content specifies how that content should visually appear if no other style template applies to the content type.

When generating a style definition for a transformed content item, the style module 220 identifies components in the transformed content item and assigns a style template to the component based on its type and, optionally, the publisher 130 from which the corresponding raw content item was received. For example, the style module 220 selects a block style template for a top-level component that specifies how that top-level component is to be displayed as a whole. For a component having textual content, the style module 220 selects a text style template that specifies how the text appears visually. If the publisher 130 has provided custom style templates for the corresponding raw content item, then the style module 220 assigns the relevant custom style templates to the components in the transformed content item. The style module 220 generates the style definition associated with the transformed content item based on the assignments of style templates to components in the content item. In one embodiment, the style definition includes only the identifiers of the selected style templates. In an alternative embodiment, the style definition stores a copy of the selected style templates. Once generated, the style module 220 stores the style definition in association with the transformed content item in the item store 230.

The transmission module 235 transmits transformed content items to the clients 110 for display. The transmitted content items include the transformed components, the metadata, and the style definition associated with the transformed content items. In one embodiment, the transmission module 235 receives a request for content items from a client 110 and, responsive to the request, transmits one or more transformed content items to the requesting client 110. In another embodiment, the transmission module 235 transmits transformed content items to a client 110 when the content items become available or are otherwise determined to be of interest to a user of the client 110.

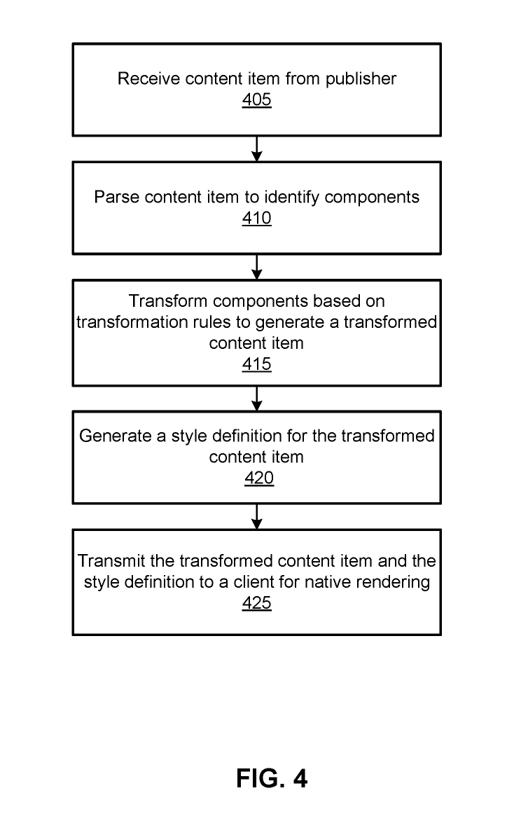

FIG. 4 is a flow chart illustrating a process for transforming digital content items received from a publisher 130 to enable native rendering, according to an embodiment. Other embodiments may include different and/or additional steps. In addition, the steps may be performed in different orders.

In step 405, the transformation module 210 receives a content item from a publisher 130. The content item is organized as a web-based markup language document having multiple components. Examples of components included in a received content item include text, block quotes, images, advertisements, embedded functions, etc. A given component may include one or more nested components that depend on the given component.

In step 410, the transformation module 210 parses the content item received from a publisher 130 to identify each of the components included in the content item. In step 415, the transformation module 210 transforms the identified components based on one or more transformation rules to generate a transformed content item having an ordered stack of components. A transformation rule describes how at least one type of component of a digital content item is to be transformed to make the component compliant with the native data model that enables native rendering. In operation, the transformation module 210 applies at least the flatten transformation rule stored in the transformation rules store 215 to the components to transform each component into an independent top-level component.

When the transformation module 210 applies the flatten transformation rule, the transformation module 210 extracts each nested component within a top-level component and generates a top-level component from each extracted nested component. The transformation module 210 organizes the generated top-level components as an ordered stack of components. The order of the top-level components matches the order of the components within the raw content item. In one embodiment, the transformation module 210 treats an inline element within a nested component as a nested component as well and thus generates a top-level component from the inline element. In an alternative embodiment, the transformation module 210 maintains the dependency between a nested component and its dependent inline elements and does not generate a top-level component from the inline element.

In step 420, the style module 220 generates a style definition for the transformed content item. The style definition specifies how the various components in the transformed content item are to appear visually when displayed by a client 110. In operation, the style module 220 selects style templates from the style store 225 based on the types of components in the transformed content item. The style module 220 generates the style definition associated with the transformed content item from the selected style templates. In step 425, the transmission module 235 transmits the transformed content item and the style definition to a client 110 for native rendering.

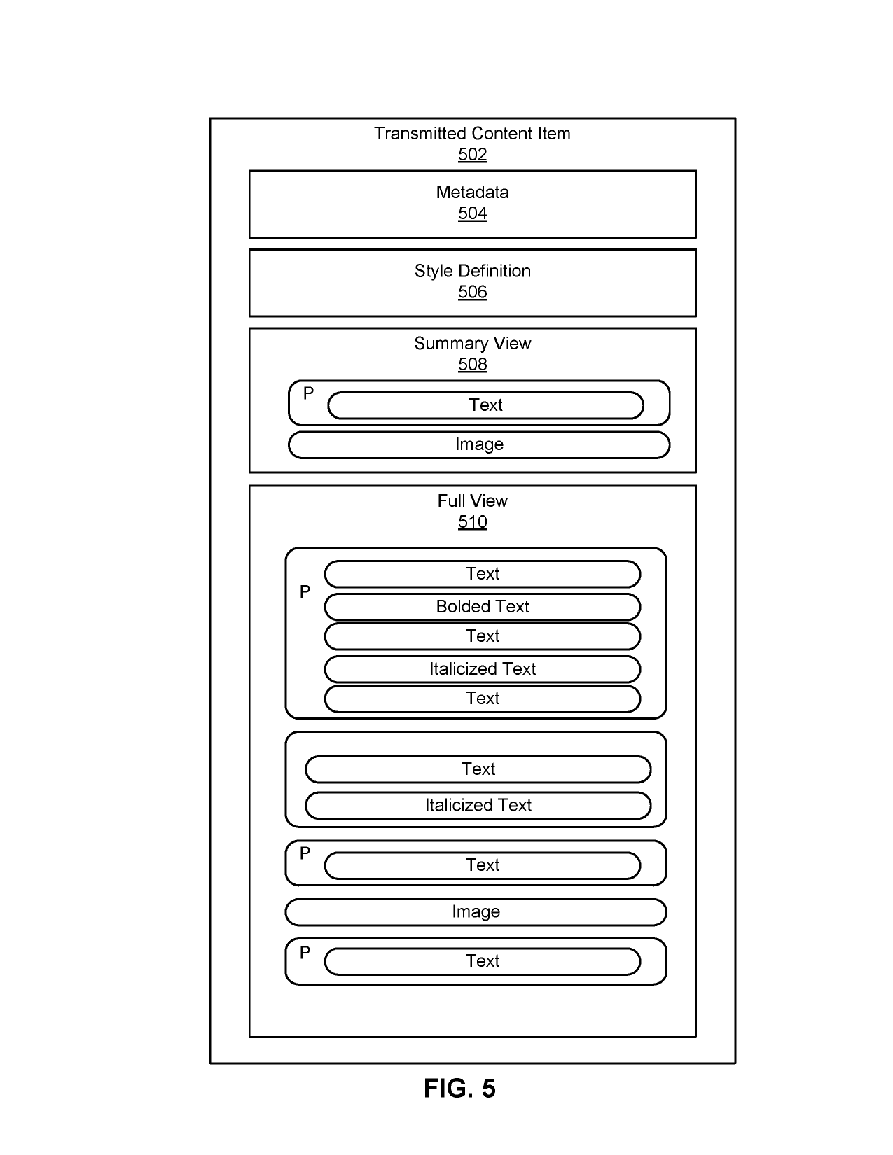

FIG. 5 illustrates a content item 502 transmitted to a client 110 by the content distribution system 140, according to an embodiment. The content item 502 includes the transformed components and associated information generated by the transformation module 210 and the style module 220 when processing the raw content item 302 of FIG. 3. The client 110 is configured to natively render the content item 502 according to the transformed components and the associated information. In one embodiment, all the information needed by the client 110 to render the content item 502 is included within the content item 502, such that the client 110 does not need to fetch information, (for example, an image embedded within the content item 502), from an external source.

As shown, the content item 502, transmitted to the client 110 for native rendering includes metadata 504, a style definition 506, a summary view representation 508, and a full view representation 510. The metadata 504 includes information associated with the content item, for example, a source name, a publication date, and/or an author's name. The style definition 506 includes the definition generated by the style module 220 that specifies how the various components in the summary view representation 508 and the full view representation 510 are to appear visually. The full view representation 510 includes the transformed components associated with the content item 502 that are organized in an ordered stack. The summary view representation 508 includes a subset of the transformed components included in the full view representation 510.

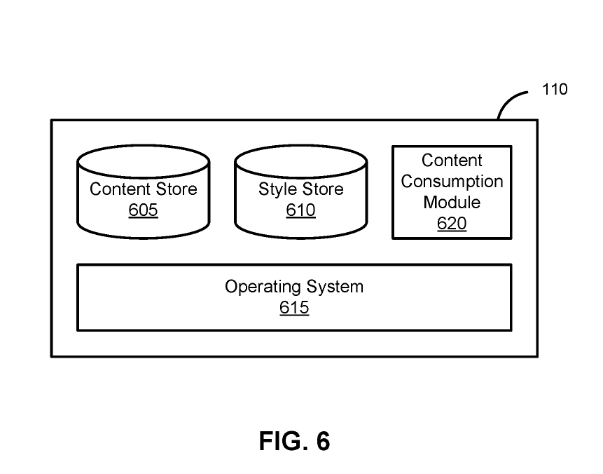

FIG. 6 is a block diagram illustrating details of a client 110, according to an embodiment. The client 110 includes a content store 605, a style store 610, an operating system 615, and a content consumption module 620.

Those of skill in the art will appreciate that the client 110 may include different and/or additional modules appropriate for its functionality (e.g., social networking, banking, commerce, etc.). Further, the functions of the modules described herein may be distributed among the modules in a different manner. The content store 605 and the style store 610 are implemented using non-transitory computer readable storage devices, and suitable database management systems for data access and retrieval. In one embodiment, the content store 605 and/or the style store 610 are implemented in a database management system, such as a relational database (e.g., My SQL). The content store 605 and/or the style store 610 may be distributed from one another and/or remote from the client 110. The client 110 may include other hardware elements necessary for the operations described here, including network interfaces and protocols, input devices for data entry, and output devices for display, printing, or other presentations of data.

The content store 605 stores transformed content items received from the content distribution system 140. A transformed content item in the content store 605 includes transformed components, metadata, and a style definition. In one embodiment, the transformed components may be categorized into a summary view representation and a full view representation. The style store 610 stores different style templates that are to be applied to transformed content items stored in the content store 605. In one embodiment, the style definition included in a transformed content item stores only the identifiers of the style template to be applied to the transformed components, and the style store 610 stores the corresponding templates in association with the identifiers. The style store 610 receives the style templates from the content distribution system 140 in conjunction with content items or in an independent communication.

The operating system 615 manages hardware and software resources of the client 110 and provides native services to programs executing on the client 110. Examples of native services provided by the operating system include caching, memory management and profiling, display and rendering controls, etc. Programs executing on the client 110 may implement various functionality utilizing the native services provided by the operating system 615.

The content consumption module 620 displays content items stored in the content store 605 to users of the client 110 based on native services provided by the operating system 615. In operation, the content consumption module 620 retrieves a content item from the content store 604 and renders one or more components included within the content item using native rendering controls provided by the operating system 615. The content consumption module 620 renders the components according to the order in which those components are organized within the ordered stack of the content item. Further, for each component to be rendered, the content consumption module 620 determines a style template assigned to the component based on the style definition associated with the content item. The content consumption module 620 retrieves the assigned template from the style store 610 and sets the visual appearance of the component according to the specification of the assigned template.

When the content consumption module 620 encounters a complex component during rendering, the content consumption module 620 identifies an internal program that implements the function associated with the complex component and executes the program. The inputs to the program may be determined based on other components of the content item. As discussed above, the complex component may be a social media share button for sharing content on a social media platform. If the social media share button is clicked by a user of the client 110, then the content consumption module 620 executes the internal program associated with the social media share button.

In one embodiment, the content consumption module 620 implements special effects when rendering the content item, where the special effects are enabled by the ordered stack of components of the content item. For example, the content consumption module 620 may implement a seamless visual transition from a summary view representation of the content item to a full view representation of the content item. The components of the content item that need to be rendered for the summary view representation and the full view representation and the associated style templates are concurrently available in the content store 605. Therefore, the transition between the summary view representation and the full view representation does not require fetching additional content or information from an external source, making the transition smooth and quick. In another example, the content consumption module 620 may implement a parallax display effect that allows different rendered components of the content item to be scrolled at different speeds.

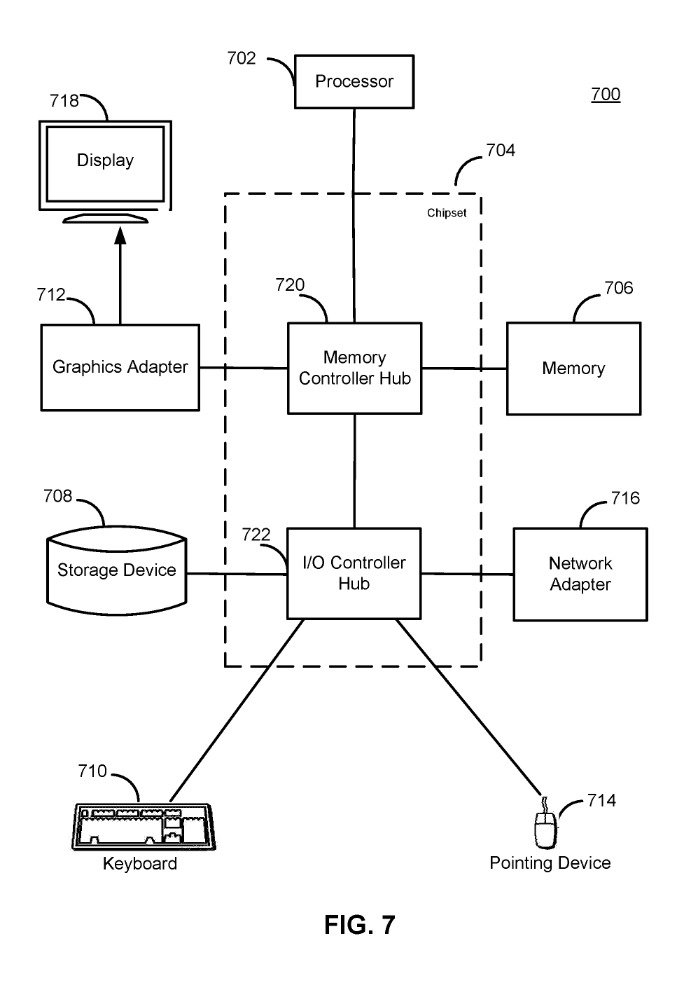

The entities shown in FIG. 1 are implemented using one or more computers. FIG. 7 is a high-level block diagram of a computer 700 for acting as the content distribution system 140, the publisher 130, and/or a client device used by a client 110, according to one embodiment. Illustrated are at least one processor 702 coupled to a chipset 704. Also coupled to the chipset 704 are a memory 706, a storage device 708, a keyboard 710, a graphics adapter 712, a pointing device 714, and a network adapter 716. A display 718 is coupled to the graphics adapter 712. In one embodiment, the functionality of the chipset 704 is provided by a memory controller hub 720 and an I/O controller hub 722. In another embodiment, the memory 706 is coupled directly to the processor 702 instead of the chipset 704.

The storage device 708 is any non-transitory computer-readable storage medium, for example a hard drive, compact disk read-only memory (CD-ROM), DVD, or a solid-state memory device. The memory 706 holds instructions and data used by the processor 702. The pointing device 714 may be a mouse, track ball, touch sensitive display, or other type of pointing device, and is used in combination with the keyboard 710 to input data into the computer system 700. The graphics adapter 712 displays images and other information on the display 718. The network adapter 716 couples the computer system 700 to the network 120.

As is known in the art, a computer 700 can have different and/or other components than those shown in FIG. 7. In addition, the computer 700 can lack certain illustrated components. For example, the computers acting as the content distribution system 140 can be formed of multiple blade servers linked together into one or more distributed systems and lack components for example keyboards and displays. Moreover, the storage device 708 can be local and/or remote from the computer 700 (for example embodied within a storage area network (SAN)).

The computer 700 is adapted to execute computer program modules for providing functionality described herein. As used herein, the term “module” refers to computer program logic utilized to provide the specified functionality. Thus, a module can be implemented in hardware, firmware, and/or software. In one embodiment, program modules are stored on the storage device 708, loaded into the memory 706, and executed by the processor 702.

The above description is included to illustrate the operation of the preferred embodiments and is not meant to limit the scope of the invention. The scope of the invention is to be limited only by the following claims. From the above discussion, many variations will be apparent to one skilled in the relevant art that would yet be encompassed by the spirit and scope of the invention.

What is claimed is:

1. A computer-implemented method for transforming content to enable native rendering, the method comprising:
receiving from a publisher of digital content a content item formatted according to a web-based markup language, the markup language associated with a web-based rendering engine for rendering the content item;
parsing the content item to identify a plurality of components of the content item, a first component of the plurality having a dependent nested component;
transforming the plurality of components into an ordered stack of components based on a transformation rule associated with native rendering, the transformation rule specifying that the ordered stack of components include the nested component as a top-level component independent of the first component; and
transmitting the ordered stack of components to a client for native rendering without invoking the web-based rendering engine.

2. The method of claim 1, wherein transforming the plurality of components comprises extracting the nested component from the first component of the plurality and ordering the first component as a top-level component in the ordered stack of components.

3. The method of claim 1, wherein a second component in the plurality of components is an embedded function, and wherein transforming the plurality of components comprises applying a second transformation rule associated with native rendering to the second component, the second transformation rule specifying that the embedded function be transformed into a complex content type having a corresponding program configured in the client.

4. The method of claim 1, wherein transforming the plurality of components comprises generating a summary view representation of the content item having a subset of the components in the ordered stack, and a full view representation of the content item having all of the components in the ordered stack, and transmitting comprises concurrently transmitting the summary view representation and the full view representation to the client for native rendering.

5. The method of claim 1, further comprising generating a style definition associated with the ordered stack of components, the style definition specifying a visual style to be applied to at least one of the components in the ordered stack when the at least one component is natively rendered by the client.

6. The method of claim 5, further comprising transmitting the style definition in conjunction with the ordered stack of components to the client, the client configured to apply the style definition when rendering the ordered stack of components based on the visual style specified in the style definition.

7. The method of claim 5, wherein generating the style definition comprises selecting the visual style to be applied to at least one of the components in the ordered stack based on the publisher of the digital content.

8. The method of claim 5, wherein generating the style definition comprises selecting the visual style to be applied to at least one of the components in the ordered stack based on the content type of the at least one component.

9. The method of claim 5, wherein the style definition identifies a style template associated with the visual style to be applied to at least one of the components, and the style template is locally stored at the client.

10. A non-transitory computer-readable storage medium storing executable computer program instructions for transforming content to enable native rendering, when executed by a processor, cause the processor to:
receive from a publisher of digital content a content item formatted according to a web-based markup language, the markup language associated with a web-based rendering engine for rendering the content item;
parse the content item to identify a plurality of components of the content item, a first component of the plurality of components having a dependent nested component;
transform the plurality of components into an ordered stack of components based on a transformation rule associated with native rendering, the transformation rule specifying that the ordered stack of components include the nested component as a top-level component independent of the first component; and
transmit the ordered stack of components to a client for native rendering without invoking the web-based rendering engine.

11. The computer-readable storage medium of claim 10, wherein transforming the plurality of components comprises extracting the nested component from the first component of the plurality of components and ordering the first component as a top-level component in the ordered stack of components.

12. The computer-readable storage medium of claim 10, wherein a second component in the plurality of components is an embedded function, and wherein transforming the plurality of components comprises applying a second transformation rule associated with native rendering to the second component, the second transformation rule specifying that the embedded function be transformed into a complex content type having a corresponding program configured in the client.

13. The computer-readable storage medium of claim 10, wherein transforming the plurality of components comprises generating a summary view representation of the content item having a subset of the components in the ordered stack, and a full view representation of the content item having all of the components in the ordered stack, and transmitting comprises concurrently transmitting the summary view representation and the full view representation to the client for native rendering.

14. The computer-readable storage medium of claim 10, wherein the instructions, when executed, further cause the processor to generate a style definition associated with the ordered stack of components, the style definition specifying a visual style to be applied to at least one of the components in the ordered stack when the at least one component is natively rendered by the client.

15. The computer-readable storage medium of claim 14, wherein the instructions, when executed, further cause the processor to transmit the style definition in conjunction with the ordered stack of components to the client, the client configured to apply the style definition when rendering the ordered stack of components based on the visual style specified in the style definition.

16. The computer-readable storage medium of claim 14, wherein generating the style definition comprises selecting the visual style to be applied to at least one of the components in the ordered stack based on the publisher of the digital content.

17. The computer-readable storage medium of claim 14, wherein generating the style definition comprises selecting the visual style to be applied to at least one of the components in the ordered stack based on the a content type of the at least one component.

18. The computer-readable storage medium of claim 14, wherein the style definition identifies a style template associated with the visual style to be applied to at least one of the components, and the style template is locally stored at the client.

19. A computer system comprising:
a processor configured to execute modules; and
a memory storing the modules that, when executed by the processor, cause the processor to:
receive an ordered stack of components associated with a content item from a content distribution system, the ordered stack of components including a plurality of top-level components that are to be natively rendered,
receive a style definition associated with the ordered stack, the style definition specifying a visual style to be applied to the ordered stack when the ordered stack is natively rendered, and
render, using native rendering controls provided by an operating system executing on the processor, each of the plurality of top-level components in the ordered stack based on an order of the plurality of top-level components and the style definition.

20. The system of claim 19, wherein the ordered stack is associated with a full view representation of the content item, and wherein the modules that, when executed by the processor, further cause the processor to receive, concurrently with the ordered stack, a summary view representation of the content item that includes a subset of the plurality of top-level components.

21. The system of claim 20, wherein rendering comprises transitioning from the summary view representation of the content item to the full view representation without requesting additional information from the content distribution system.
